(19) United States
(12) Patent Application Publication
(10) Pub. No.: US 2015/0204823 A1
(43) Pub. Date: Jul. 23, 2015

(54) SELF-LIMITING INJECTION ASSEMBLY FOR SAMPLE INTRODUCTION IN HPLC

(71) Applicant: IMPERIAL INNOVATIONS LTD, Greater London (GB)

(72) Inventors: Duncan Robert Casey, London (GB); Ali Salehi-Reyhani, Middlesex (GB); Beatrice Lucile Lea Eva Gauthe, Hampshire (GB)

(73) Assignee: IMPERIAL INNOVATIONS LTD, Greater London (GB)

(21) Appl. No.: 14/417,268

(22) PCT Filed: Jul. 30, 2013
(86) PCT No.: PCT/GB2013/052035

§ 371 Date: Jan. 26, 2015

(30) Foreign Application Priority Data
Jul. 30, 2012 (GB) 1213537.2

(51) Int. Cl. G01N 30/04

(52) U.S. Cl. CPC G01N 30/04

(57) ABSTRACT

A liquid chromatography device comprises one or more liquid reservoirs for a liquid medium, a sample reservoir for a sample to be analysed and a chromatography column in fluid communication with the liquid reservoir and the sample reservoir. The device comprises a monitoring mechanism for monitoring the number of times a sample is released from the sample reservoir into the chromatography column.

This invention relates to a liquid chromatography device.

### BACKGROUND

The field of high pressure liquid chromatography is described in M. Dong, Modern HPLC for Practising Scientists, Wiley, 2006. Briefly, chromatography is used to separate, identify and quantify compounds from a sample consisting of a mixture of compounds. The sample is dissolved in a fluid mobile phase, which interacts with an immobile, immiscible stationary phase. In high pressure liquid chromatography (HPLC) the stationary phase is usually a column packed with particles, which may be functionalised. The phases are chosen based on the analyte of interest's affinity towards them, relative to that of the rest of the sample. As the mobile phase moves through the stationary phase, the individual sample components will be retained by the stationary phase to varying degrees and will become separated. The retention time varies depending on the interaction strength with the stationary phase, the composition of solvent used and the flow rate of the mobile phase.

Separation power increases with smaller stationary phase particle size. However, this increases the resistance to flow making the use of high pressures desirable. High pressure liquid chromatography drives the mobile phase through columns containing particles of typical diameters 5-10 micrometres. The first HPLC pumps were capable of 500 psi, with 6000 psi typical today. Ultrahigh pressure liquid chromatography (UPLC) consists of plumbing and pumps capable of performing at 100,000 psi required to drive solvent through columns containing even smaller particles of the order of 1 micrometre diameter. As a result, there is a need to introduce small, controlled volumes of analyte into the flow path without disassembling and ideally without depressurising the system.

This requirement has previously been satisfied by multi-position rotary valves incorporating sample loops, such as those developed by Rheodyne Inc (see for example U.S. Pat. No. 4,068,528 (1978), Two position rotary valve for injecting sample liquids into an analysis system). While effective and reliable, these assemblies are designed with durability in mind, typically machined from steel and intended to last for many years. While this is ideal for routine laboratory purposes, it means they require trained operators to prevent sample carry-over and potential contamination between runs, particularly when handling biological fluids or samples containing trace contaminants. For example, it is reported by M. C. McMaster in “LC/MS: a practical user's guide” (Wiley-Blackwell, 2005, p33) that “By far the most troublesome parts of an HPLC system are pump check valve blockage, injector loop contamination, and column contamination”.

Furthermore, they are complex, expensive and relatively large, rendering them unsuitable for use in novel, portable platforms designed for fieldwork or point-of-care studies. These and other related issues are resolved by the invention disclosed below, at least in its preferred embodiments. WO 2011/161481 discloses a miniature high pressure liquid chromatography device to which the invention may be applied. The content of WO 2011/161481 is incorporated herein by reference.

### BRIEF SUMMARY OF THE DISCLOSURE

In accordance with the present invention there is provided a liquid chromatography device comprising one or more liquid reservoirs for a liquid medium, a sample reservoir for a sample to be analysed and a chromatography column in fluid communication with the liquid reservoir and the sample reservoir, wherein the device comprises a monitoring mechanism for monitoring the number of times a sample is released from the sample reservoir into the chromatography column.

The monitoring mechanism may limit the number of times a sample can be released from the sample reservoir into the chromatography column. The monitoring mechanism may limit the release of a sample into the chromatography column to a single instance. The monitoring mechanism may comprise a counter for indicating the number of times a sample has been released into the chromatography column.

The monitoring mechanism may be electronic. The monitoring mechanism may be mechanical. The monitoring mechanism may comprise a ratchet.

The device may comprise a fluid transport mechanism for releasing a sample from the sample reservoir into a flow path from the liquid reservoir to the chromatography column, wherein movement of the fluid transport mechanism to release said sample into the flow path triggers the monitoring mechanism. The fluid transport mechanism may be rotary. The fluid transport mechanism may comprise a plunger. The monitoring mechanism may comprise a retaining mechanism for preventing removal and re-use of the plunger after the sample has been released into the flow path.

The device may further comprise a gas reservoir for containing a volume of gas under pressure to force liquid from the liquid reservoir through the chromatography column, in use.

The device may be battery powered. Alternatively or in addition, the device may be powered via a USB connection. The device may be disposable.

The liquid chromatography device may comprise one or more liquid reservoirs for a liquid medium, a sample reservoir for a sample to be analysed and a chromatography column in fluid communication with the liquid reservoir and the sample reservoir. The device may further comprise a gas reservoir for containing a volume of gas under pressure to force liquid from the liquid reservoir through the chromatography column, in use. The gas reservoir may be used to propel the liquid through the chromatography column, so that an electrically- or mechanically-driven pump is unnecessary.

The device may comprise a valve to control release of the gas from the gas reservoir. The gas reservoir may be sealed by a rupturable closure, which is ruptured to release the gas, in use. In this way, the gas reservoir may be single-use. The gas reservoir and the liquid reservoir may be separated by a deformable membrane or other piston head. In this way, the gas can propel liquid through the chromatography column without the gas contacting the liquid.

The chromatography column may be provided in a channel having a width in the range of 1 to 5,000 micrometres, preferably 20 to 200 micrometres. The chromatography column may be provided in a channel having a length in the range of 1 to 100 centimetres, preferably 2 to 20 centimetres.

The device may comprise one or more detectors downstream of the chromatography column. The detector(s) may be optical, electrical, radiological, for example. The detector(s) may be arranged about a fluid channel in fluid communication with the chromatography column. The detection path of the detector(s) may be transverse, for example perpendicular, to the flow path of the fluid. Alternatively, the detection path of the detector(s) may be substantially parallel to the flow path of the fluid.

The optical detector(s) may comprise, for example, one or more photodiodes. The optical detector may comprise one or more LEDs as a light source.

The optical detector may comprise opposed reflective surfaces on opposite sides of the fluid channel, the opposed reflective surfaces defining an optical cavity. The reflective surfaces may be provided as a layer on the walls of the fluid channel. The optical detector may comprise multiple light sources.

The device may comprise a fluid disposal reservoir in fluid communication with the chromatography column for retaining fluid that has passed through the column for subsequent disposal.

The device may be connectable to a handheld data processing device, such as a smartphone, for processing the results of the chromatography. Alternatively, it may slot into a dedicated data processing unit as a cartridge.

### BRIEF DESCRIPTION OF THE DRAWINGS

Embodiments of the invention are further described hereinafter with reference to the accompanying drawings, in which:

FIG. 1 is a schematic diagram of an embodiment of a single-use, mechanical injector according to an embodiment of the invention;

FIG. 2 is a schematic diagram of an embodiment of a multi-injection rotary valve system according to an embodiment of the invention;

FIG. 3 is a schematic diagram showing the flow path inside the load/inject switch of the system of FIG. 2; and

FIG. 4 is a schematic diagram of a HPLC device for use with the present invention.

### DETAILED DESCRIPTION

Embodiments of the present invention relate to miniaturising the format of high pressure liquid chromatography by use of a gas reservoir for pumping the mobile phase, to a point where it is fully portable and/or disposable. Embodiments of the invention provide a miniaturised and simplified sample injector assembly for HPLC that incorporates a device or devices to deliberately and artificially limit the number of possible injections it may perform. This limiting device serves to prevent repeated use of the device, for example when handling biological fluids containing communicable or dangerous agents. However, it may also serve to protect the performance of a portable HPLC, which will by its nature depend upon a finite power source.

An embodiment of the invention comprises
1. A sample chamber or loop that may be filled to excess without coming into contact with the normal solvent flow, from the reservoir into the HPLC column.
2. A flow path leading through the device, typically from the reservoir to the start of the separation stage.
3. A mobile component which introduces this sample into the flow path to load it onto the column.
4. A static component or static components for structural purposes and to act as a guide for the mobile component.
5. A mechanical and/or electrical counter to record the total number of injection steps.
6. A mechanical and/or electrically actuated block to prevent further injections once a pre-set total has been reached.
7. Microelectronics capable of registering this blocking step taking place and displaying an indication to that effect.

The instrument is intended to be disposable or to form part of a disposable platform. It may be configured for a single injection, such as when handling radioactive materials or dangerous biological fluids, or it may be designed for hundreds or thousands of runs, depending upon the desired application. It may form an integral part of a portable HPLC platform, or may be a cartridge-style insert into a longer-lived machine in order to minimise contamination at the injection stage.

The sample chamber or loop will typically be formed of an inert material such as stainless steel or polyethylethylketone (PEEK) and capable of resisting the high pressures of HPLC. It can be produced with any cross-sectional profile and contain any desired volume, but in the preferred embodiment will contain 100 nl-100 μl with a diameter of 1-1000 μm. It may comprise a loop such as in traditional HPLC injector systems in which case the entire volume of the loop will be loaded onto the column; alternatively it may be driven by a piston or plunger to load only a small, controlled volume at a time.

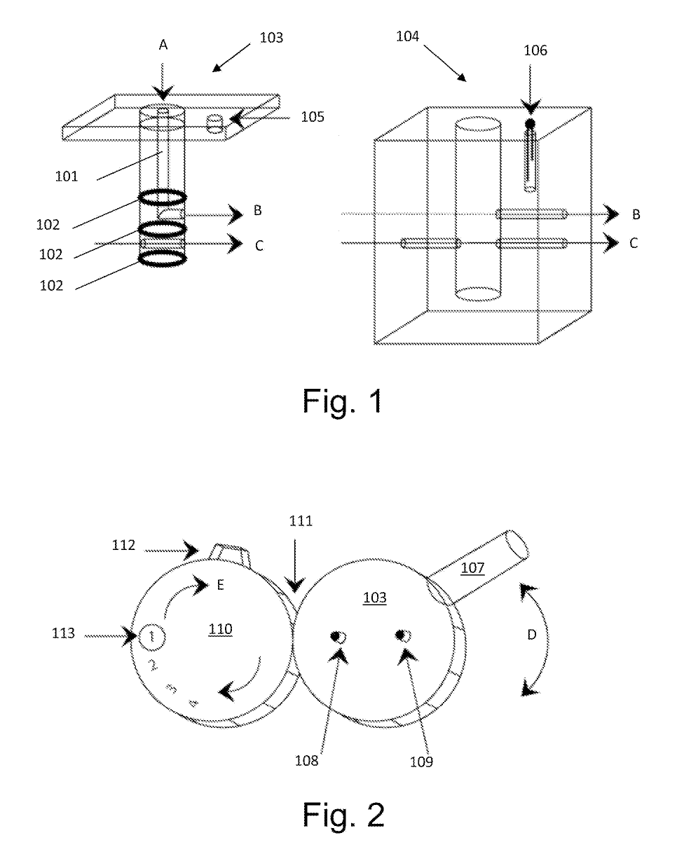

The moving component may be rotary such as in FIG. 2 or may involve other designs such as a plunger shown in FIG. 1. If a plunger or related design is used, it may be necessary to incorporate an independent flow control valve between the reservoir and the injector to prevent leaks. In either case, the component is largely structural and so may be fabricated from a wide range of materials. However, the wetted surfaces must be either chemically resistant or be lined with a chemically resistant material to protect both the component from corrosion and the solvent from contamination. Many materials are available for such purposes, including but not limited to stainless steel, PEEK, glass-filled polyphenylene sulphide (PPS) or polyimide. Flow paths for each of the preferred embodiments are shown on their respective diagrams. Motion of the component may be controlled either electronically or manually, depending upon the demands of the target application.

The static component(s) are, in both of the preferred embodiments shown in the Figures, largely structural in role and so may be comprised of many materials. As previously, any and all wetted surfaces in these components must be chemically resistant to prevent corrosion and contamination. The flow path may have any cross-sectional profile and have dimensions of 1-1000 μm.

The counter may take one of several forms. In one of its simplest embodiments, a single-use device may be formed via the use of a split pin or other sprung device contained within the static component of the plunger casing as in FIG. 1. As shown in FIG. 1, the sample is inserted into a sample chamber 101 (as indicated by arrow A) and waste sample can exit the sample chamber 101 (as indicated by arrow B). Sealing rings 102 are provided about the mobile component 103 to form a seal when the mobile component 103 is inserted into the static component 104. A normal solvent flow path is provided through the mobile component 103 and the static component 104 (as indicated by arrow C). A clip 105 is provided in the mobile component 103 to retain a sprung pin 106 in the static component 104, when the mobile component 103 is inserted into the static component 104. In this embodiment, the pin 106 is captured during the first injection and springs upon withdrawal to prevent subsequent use. This pin may make contact with a conducting surface allowing the electronic detection and indication to the user of its release.

In an embodiment more suited to repeat usage, the rotary motion of the mobile component may cause a ratchet to be turned with each injection. As shown in FIG. 2, a rotary mobile component 103 is provided with a load/inject switch 107 which causes the mobile component 103 to rotate (as indicated by the arrow D). The mobile component 103 is provided with an injection port 108 and a waste sample outlet 109. A blocking component 110 engages with the mobile component 103 by means of interlocking teeth 111 on the periphery of the mobile component 103 and the blocking component 110. The blocking component 110 rotates with each injection of the mobile component 103 (as indicated by arrows E) as a result of the inter-engagement of the teeth 111. A projection 112 on the blocking component 110 prevents further injections after the fourth by physically blocking further rotation of the mobile component 103. An injection counter indicator window 113 is provided on the blocking component 111 to indicate the number of injections that have occurred. The total number of injections available would thus be controlled by the size and shape of the ratchet, with the final step introducing a block to disable the rotor 103. This design has the additional benefit that as the ratchet turns, a numeral may be displayed directly showing the number of available injections remaining. Alternatively, either design may be replaced by an electronically-actuated counter and stop triggered by a TTL pulse or similar, which may also be used to trigger the start of data collection during an HPLC run.

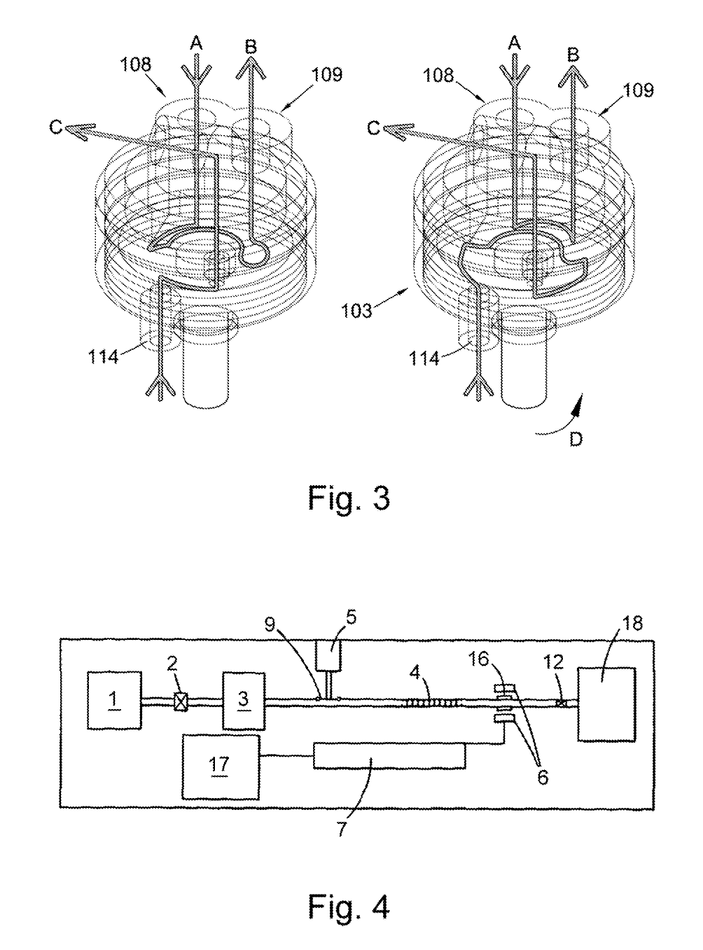

FIG. 3 shows the flow path within the device of FIG. 2. The flow path for the sample between the injection port 108 and the waste sample outlet 109 is indicated by the arrows A and B. The flow path for the mobile phase to the chromatography column is indicated by arrow C. The mobile phase enters the device through a solvent port 114. In the left-hand diagram of FIG. 3, the sample is loaded into the device. In the right-hand diagram of FIG. 3, the rotor 103 is rotated to actuate a valve so that the mobile phase contacts the sample and the sample is on-line.

Indication that the total number of runs has reached the device's pre-set limit may be delivered in a number of ways: mechanically, as described above, or an electronic signal may cause the illumination of an indication display or LED. Alternatively, the HPLC software may be directly utilised to display messages regarding the state of the injector in more detail. On-board electronics and any communications with external equipment may be driven by a simple microcontroller.

FIG. 4 shows a miniaturised HPLC device in which pressure to move the mobile phase is provided by release of gas from a pre-pressurised reservoir, dispensing with the need for a conventional pump integrated into the device. The device may be portable and disposable. As exemplified in FIG. 4, the device comprises a pump system consisting of a gas reservoir 1 containing pre-pressurised gas at a pressure suitable for running HPLC and a (solenoid) valve 2 which when opened provides pressure to drive the mobile phase through the HPLC column. The device further comprises a mobile phase reservoir 3 and capillary column 4 packed with a solid phase suitable for HPLC separation. A sample introduction system comprises a sample reservoir 5. A detection system 6 is provided that is capable of detecting analyte fractions separated by the HPLC stage. In the example shown the detection system 6 comprises a light emitting diode (LED) and a photodiode. A microelectronic controller 7 is provided that is capable of controlling the device and processing data from the detection system 6.

As the instrument is intended to be disposable after a lifetime of 1-1000 injections, it does not have the same longevity requirements that make existing models so large and cumbersome.

The pump gas reservoir 1 may be a plastic or inert metal-walled cylinder. The valve 2 is preferably electronically controlled, such as a solenoid valve. However, if the device is intended as single use the gas may be released via a mechanism which breaks a perforable seal on the gas reservoir.

The small column volume means that a gas stored under pressure has limited space to expand, driving solvent before it at a rate that is predictable and reproducible assuming there are no major changes in temperature during a run. The pressure of the gas does not alter significantly during the working life of the unit, meaning that repeated analyses produce identical conditions within the device, and thus identical retention times.

A wide range of gases may be used. For example, nitrogen is cheap and inert. The gas in the gas reservoir and the mobile-phase in the mobile-phase reservoir may be separated by a deformable membrane or other piston head.

The gas reservoir 1 should be large enough that the fall in pressure in moving mobile phase through the column volume is small. For a gas that behaves approximately as an ideal gas the fractional drop in pressure is equal to the fractional increase in volume. Therefore a reservoir 1 of 10 cubic centimetres moving mobile phase through a 10 microlitre column volume will experience a pressure drop of 0.1%. This could conveniently be contained in a spherical reservoir with an inner diameter of 27 millimetres.

The device can function with larger pressure drops, such as 1% or 10%. Because the drop is always reproducible it can be compensated for when identifying peaks at a data processing stage.

Larger reservoirs may be used for larger column volumes, for greater precision or to make multiple separations through the same column volume. A handheld device could easily contain a 100 cubic centimetre reservoir.

The pressure provided by the pumping system is subject to variation with temperature. For an ideal gas a change in temperature of 3 Kelvin is expected to change the pressure by about 1%. The device may optionally incorporate a temperature sensor so that any such variation can be corrected for at a data processing stage. The device may also optionally include mechanisms for heating or cooling, such as ohmic heating or thermoelectric cooling.

The working column volume of the device is typically of the range of 0.1-10 microlitres, meaning that a mobile phase reservoir of 1-5 ml permits hundreds of column volumes of chromatography. If the device comprises more than one mobile phase reservoir, eluents may be mixed via the activity of valves permitting the creation of gradient elution profiles; devices with just one reservoir are restricted to isocratic analyses.

Where the device comprises a single reservoir 3, an isocratic analysis will involve the column being first wetted with solvent followed by elution of a sample plug through the solid phase.

The sample is loaded into the device via a dedicated sample line. A check valve 9 installed at the union of the sample line and column ensures any sample loaded into the device is not returned. An electronically actuated valve 2 is installed between the gas reservoir 1 and the check valve 3 which controls the flow of the mobile phase through the column. The valve 2 is switched to enable the correct sequence of wetting, loading and elution of the column. In the exemplified embodiment the valve is a hydraulic solenoid controlled by the on-board microelectronics 7 which is capable of withstanding pressures typical of HPLC.

Alternatively, the sample may be introduced through a sample introduction loop switched into the column path, as in conventional HPLC.

The separation stage of the device comprise a capillary 4 or micro-machined channel within a substrate with an inner diameter in the range of 1-5000 micrometres and a length of 1-100 cm, filled with a solid phase bed of either particulate material such as silica, with a polymer structure, or with an inorganic monolith structure. This packing may be functionalised to give specific chemical or structural selectivity, or it may contain pores of controlled size in order to separate mixtures via diffusive processes as in size exclusion chromatography. In general, any of the solid phases applicable to HPLC may be used.

In a preferred embodiment the column is a packed fused-silica capillary with inner diameter in the range 20-200 micrometres, length in the range 2-20 cm and with optical transparency suitable for use with UV absorption measurements. The packing of capillary and compatible connections have been documented elsewhere (E. Rapp & E. Bayer, J. Chromatography A, 2000 (887) pp 367-378).

In order to prevent dissolved gas effervescing from the eluent stream in the device in between the column and the detection stage 6, a back pressure regulator 12 may be fitted to the end of the solvent path. This is configured to supply a back-pressure equivalent or greater than the pressure exerted by the separation phase, meaning that de-gassing of the eluent stream is prevented until it has left the device. Alternatively, the use of a membrane or piston head between gas and solvent minimises such effects.

The detection system may be optical, electrical or radiological, the choice of which will be dependent on the intended application of the device. In the exemplified embodiment the detection system is based on optical detection. The optical detection system 6 comprises one or an array of light emitting diodes (LEDs) which form a source and one or an array of photodiodes operating in the ultraviolet, visible or infra-red wavelength regions, which form a detector. The optical cavity 16 may be formed by coating the capillary or channel with a suitable dielectric. This makes the detection apparatus amenable to mass production. In the exemplified embodiment the mode of detection is UV-VIS absorption spectroscopy. Light is passed through the sample and a signal is detected by a photodiode. The strength of the signal is inversely proportional to the amount of absorber in the detection path. The absorbance is characteristic for any given compound at any given wavelength.

The short path length available for absorption makes desirable systems to increase sensitivity by enhancing absorption. Absorption may be enhanced using a multipass arrangement and forms the basic principle of cavity ring-down spectroscopy (CRDS, described in detail in L. Van der Sneppen et al, Annu. Rev. Anal. Chem 2009 2 pp 13-35). The CRDS setup typically consists of a light source used to illuminate an optical cavity, which may simply be composed of two highly reflective mirrors. Highly reflective mirrors or coatings are provided on either side of the detection path so that multiple light paths through the absorber are created.

In one embodiment the HPLC unit may be connected to a data processing device such as a smart phone or a personal computer. The connection may be wired or wireless for example by a USB interface. The device may process data uploaded from the HPLC unit, providing access to chromatograms, identification and quantification of analytes. The device may also be capable of transmitting data via a telecommunication network for remote processing.

The connection to the data processing device may also be used to deliver power to the HPLC unit, for example through a USB cable. The power requirements of the HPLC unit are low enough to have a small impact on the battery life of a portable PC or smartphone. By making use of a battery and processing power in an attached data processing device the cost and size of the HPLC unit may be further reduced. The power module 17, which may be a battery or USB connection, for example, is shown in FIG. 4.

This data processing device may also be capable of transmitting data via a telecommunication network for remote processing. Such data processing may be also performed locally on a sufficiently computationally powerful device such as a smartphone.

Another embodiment of the device enables entirely stand-alone operation, for use as a field diagnostic test. In this case, power may be supplied either by a battery or via a small solar cell, whereas the data readout may be visualised using an integrated LCD or LED display. By minimising the use of moving parts and by using low power, solid-state components wherever possible, the power consumption of the device is so small as to allow fully wire-free operations in regions or environments where mains power is unavailable. Data gathered in this embodiment of the device may be stored on a removable memory unit such as a flash memory card for later analysis.

Once the sample has been analysed by the device it may be passed into a waste collection reservoir 18. This allows the sample to be catalogued for further analysis or storage. The reservoir 18 may hold samples requiring disposal in accordance with federal, state and local environmental control regulations.

In summary, a liquid chromatography device comprises one or more liquid reservoirs 3 for a liquid medium, a sample reservoir 5 for a sample to be analysed and a chromatography column 4 in fluid communication with the liquid reservoir 3 and the sample reservoir 5. The device further comprises a gas reservoir 1 for containing a volume of gas under pressure to force liquid from the liquid reservoir 3 through the chromatography column 4, in use.

In summary, a liquid chromatography device comprises one or more liquid reservoirs for a liquid medium, a sample reservoir for a sample to be analysed and a chromatography column in fluid communication with the liquid reservoir and the sample reservoir. The device comprises a monitoring mechanism for monitoring the number of times a sample is released from the sample reservoir into the chromatography column.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A liquid chromatography device comprising one or more liquid reservoirs for a liquid medium, a sample reservoir for a sample to be analysed and a chromatography column in fluid communication with the liquid reservoir and the sample reservoir, wherein the device comprises a monitoring mechanism for monitoring the number of times a sample is released from the sample reservoir into the chromatography column.

2. A device as claimed in claim 1, wherein the monitoring mechanism limits the number of times a sample can be released from the sample reservoir into the chromatography column.

3. A device as claimed in claim 2, wherein the monitoring mechanism limits the release of a sample into the chromatography column to a single instance.

4. A device as claimed in claim 1, wherein the monitoring mechanism comprises a counter for indicating the number of times a sample has been released into the chromatography column.

5. A device as claimed in claim 1, wherein the monitoring mechanism is electronic.

6. A device as claimed in claim 1, wherein the monitoring mechanism is mechanical.

7. A device as claimed in claim 6, wherein the monitoring mechanism comprises a ratchet.

8. A device as claimed in claim 1 comprising a fluid transport mechanism for releasing a sample from the sample reservoir into a flow path from the liquid reservoir to the chromatography column, wherein movement of the fluid transport mechanism or sample fluid to release said sample into the flow path triggers the monitoring mechanism.

9. A device as claimed in claim 8, wherein the fluid transport mechanism is rotary.

10. A device as claimed in claim 8, wherein the fluid transport mechanism comprises a plunger.

11. A device as claimed in claim 10, wherein the monitoring mechanism comprises a retaining mechanism for preventing removal and re-use of the plunger after the sample has been released into the flow path.

12. A device as claimed in claim 1 further comprising a gas reservoir for containing a volume of gas under pressure to force liquid from the liquid reservoir through the chromatography column, in use.

13. A device as claimed in claim 1, wherein the device is battery powered.

14. A device as claimed in claim 1, wherein the device is disposable.
